(19) United States
(12) Patent Application Publication
(10) Pub. No.: US 2014/0084055 A1
(43) Pub. Date: Mar. 27, 2014

(54) QUALITY CONTROL METHOD AND APPARATUS FOR AUTOMATED ANALYSES OF BIOLOGIC FLUID SAMPLE

(71) Applicants: Robert A. Levine, Guilford, CT (US); Stephen C. Wardlaw, Lyme, CT (US)

(72) Inventors: Robert A. Levine, Guilford, CT (US); Stephen C. Wardlaw, Lyme, CT (US)

(21) Appl. No.: 14/111,980

(22) PCT Filed: Apr. 13, 2012
(86) PCT No.: PCT/US12/33576

§ 371 Date: Nov. 20, 2013

Related U.S. Application Data
(60) Provisional application No. 61/476,054, filed on Apr. 15, 2011.

(51) Int. Cl. G01N 35/00

(52) U.S. Cl. CPC G01N 35/00613
USPC 235/375; 235/487

(57) ABSTRACT

An apparatus and method for analyzing a biologic sample is provided. The apparatus includes a capillary tube, a machine readable identity tag, and an analysis device. The tube is operable to hold the biologic sample. The machine readable identity tag is disposed on the tube, and indicates a production source of the tube. The analysis device is operable to analyze the biologic sample. The analysis device includes a reader adapted to read the identity tag, and the analysis device is operable to authenticate the tube based on the identity tag read from the tube.

This application claims the benefit of U.S. Provisional Patent Application No. 61/476,054 filed Apr. 15, 2011, which application is hereby incorporated by reference in its entirety.

### BACKGROUND OF THE INVENTION

1. Technical Field

The present invention relates to biologic fluid sample analysis methods and apparatus in general, and to quality control methods and apparatus for automated analyses of biologic fluid samples in particular.

2. Background Information

Traditionally, clinical analyses on biologic matter were performed manually by skilled technicians who used a variety of controls and standards to ensure the quality of the analytical results they produced. Analytical instruments capable of performing automated analytical procedures (e.g., measuring clinically useful analytes such as serum chemistries, immunologic reactions, hematologic information, etc.) eventually became available. These automated analytical instruments typically dispensed bulk reagents into non-disposable analytical chambers. A number of different bulk formulations of the test reagents could be used with these instruments, regardless of whether the instrument manufacturer made the reagent or not. Quality control was accomplished by a variety of measures, including the performance of standard curves, the running of multiple controls, and the like. These quality control measures were adequate because the tests were performed on the same reagents using the same methods as those used to create the standard curves and controls. However, this is not the case with many newer analytical instruments.

Many types of modern analytical instruments employ a unitized, completely disposable container that includes all of the reagents and reaction chambers used in the test. Quality control is a significant issue for these type containers. For example, few modern disposable containers include mechanisms for creating a standard curve or a control using the same reagents that are included in the container. In addition, the physical characteristics of a container's analysis chamber can vary considerably due to manufacturing tolerances. Analytical results produced using such a disposable container can, therefore, vary significantly and undesirably influence the reliability of those analytical results. Reliability can, of course, be achieved by using reagents and analysis chambers manufactured to very tight tolerances. In fact, companies who manufacture analytical instruments will often also manufacture the disposable containers and encourage users to use their brand container with their analytical instrument, as a way of increasing the reliability of the analysis. In many instances, however, third party companies will produce aftermarket disposable containers and market those containers for use in one or more analytical devices. Aftermarket disposable containers are sometimes manufactured to less discriminating standards. Consequently, an analysis performed on a name-brand analytical device might yield unreliable data not because of the analytical device, but rather because of the aftermarket container. In such a case, it may not be readily apparent which aspect of the analytical system is compromising the data. Hence, the reputation of an analytical device and its manufacturer, and even the reputation of the laboratory performing the tests, can become suspect through no fault of their own. More important, however, is the chance that the treatment of a patient might unknowingly be influenced by bad clinical data.

What is needed, therefore, is a quality control method and apparatus for automated analyses of biologic matter that can provide high quality, reliable analytical data, one that will protect the reputation of the laboratory and the instrument manufacturer, and one that will facilitate the highest quality patient care possible.

### DISCLOSURE OF THE INVENTION

According to an aspect of the present invention, an apparatus for analyzing a biologic fluid sample is provided. The apparatus includes a capillary tube, a machine readable identity tag, and an analysis device. The capillary tube is adapted to hold the biologic fluid sample. The machine readable identity tag is disposed on the tube, and the identity tag indicates a manufacturing source of the tube. The analysis device is adapted to analyze the biologic sample. The analysis device includes a reader adapted to identify the identity tag and authenticate the tube based on the identity tag.

According to another aspect of the present invention, a container for holding a biologic fluid sample for analysis for use with an automated analytical device is provided. The container includes a capillary tube for holding the biologic fluid sample, and a machine readable identity tag disposed on the tube. The identity tag provides information regarding the manufacturing source of the tube.

According to another aspect of the present invention, a method for analyzing a biologic fluid sample is provided. The method includes the steps of: a) providing a capillary tube for holding the biologic fluid sample, the tube including a machine readable identity tag disposed on the tube, wherein the identity tag provides information regarding the manufacturing source of the tube; b) providing an automated analysis device for analyzing the biologic fluid sample, wherein the analysis device includes a reader adapted to identify the identity tag and authenticate the tube based on the identity tag; c) authenticating the tube using the reader and the identity tag; and d) performing an action based on the determined authenticity of the tube.

One of the advantages of the present method and apparatus is that they facilitate consistent production of high quality, reliable analytical data. As stated above, the present apparatus and method provide a means by which the quality of a capillary tube can be assessed without physically analyzing the container itself before each analysis. As a result, there is no need for an analytical device to include the apparatus necessary to perform that quality control analysis. Nor is there any need to perform a quality control analysis on every container used. Each analysis can consequently be performed in less time and less expensively than would be otherwise possible.

The ability of the present method and apparatus to produce high quality, reliable analytical results also helps to protect the reputation of the laboratory and the instrument manufacturer. In the event a patient or caregiver receives compromised clinical data, it is unlikely they will have the ability to readily determine which aspect or aspects of the analytical procedure is at fault and will therefore assume the entire analytical procedure is at fault. There is, accordingly, considerable advantage in decreasing any potential source of error in an analytical procedure. The present method and apparatus provide an indication to an operator regarding the authenticity of a tube, and therefore the quality of that tube.

These and other objects, features and advantages of the present invention will become apparent in light of the detailed description of the present invention.

### BRIEF DESCRIPTION OF THE DRAWINGS

FIG. 1 is a diagrammatic view of a disposable container for holding biologic matter.

FIG. 2 is a diagrammatic view of an analytical device and a disposable container for holding biologic matter.

FIG. 3 is a diagrammatic perspective view of a portion of a tube, including an embodiment of an identity tag disposed on the tube.

FIG. 4 is a diagrammatic perspective view of a portion of a tube, including an embodiment of an identity tag disposed on the tube.

### DETAILED DESCRIPTION OF THE INVENTION

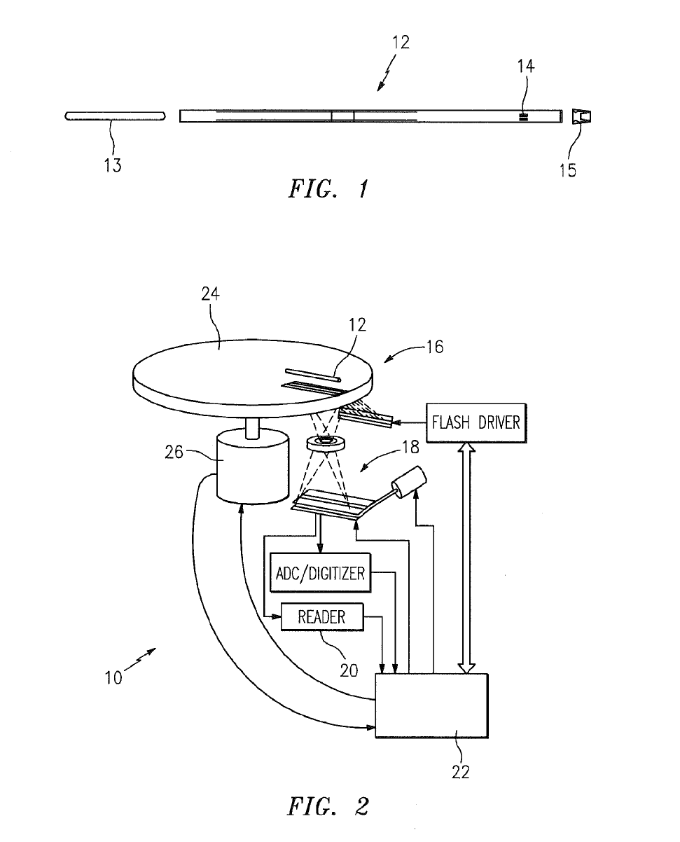

Referring to FIGS. 1 and 2, a method and apparatus for quality control of automated analyses of biologic fluid samples includes the provision of an analysis device 10 and a capillary tube type container 12 for holding a biologic fluid sample for analysis, which container 12 includes an identity tag 14. QBC™ capillary tubes, Star Tube™ capillary tubes, or QBC AccuTube™ capillary tubes, all produced by QBC Diagnostics of Port Matilda, Pennsylvania, USA, are acceptable examples of a container 12 on which an identity tag 14 can be disposed. The container 12 is referred to hereinafter as a “tube 12”. The tube 12 shown in FIG. 1 includes a float 13 and a stopper 15.

The analysis device 10 includes structure adapted to hold and centrifuge the tube 12, an imaging unit 18 adapted to image the centrifuged sample residing within the tube 12, a reader 20 adapted to identify the identity tag 14 on the tube 12, and a programmable analyzer 22 adapted to analyze images of the sample residing within the tube 12. FIG. 2 schematically illustrates structure 16 operable to hold and centrifuge the tube 12, an imaging unit 18 for imaging the contents of the tube 12, a reader 20 for identifying the identity tag 14 on the tube 12, and the programmable analyzer 22 adapted to analyze the image of the contents of the tube 12. The structure 16 for holding and centrifuging the tube 12 includes a centrifuge platen 24 with means for holding the tube 12 to the platen 24. The tube 12 is held to the platen 20 in such a manner that at least one surface of the tube 12 is available for imaging of the contents of the tube 12. As will be explained below, preferably at least one hundred and twenty degrees) (120°) of the tube's circumference is available for imaging. The centrifuge platen 20 is rotationally driven by a motor 26, which is controlled by the programmable analyzer 22. The specific rotational speed and duration of the centrifuging step(s) will vary depending upon the analysis at hand.

The imaging unit 18 is operable to image the sample disposed within the tube 12, typically as the tube 12 rotates with the platen 24. For example, a digital camera can be adapted to take an image of the tube in a manner that is synchronized with the rotational position of the platen 24 (and therefore the tube 12); i.e., the camera field is synchronized with the rotational position of the platen. An electronic image data file produced by the imaging unit 18 is then transferred to the programmable analyzer 22 where the data can be immediately analyzed and/or stored for future examination. The present invention is not limited to use with any particular type of imaging unit 18. The QBC Star™ instrument produced by QBC Diagnostics is an analysis device that is operable to perform the above described centrifuging, imaging, and analyzing processes.

The identity tag reader 20 may be independent from the imaging unit 18 or one that is incorporated with the imaging unit 18 and the programmable analyzer 22. As indicated above, there is considerable value to consumer and product source alike in decreasing the possibility of error based on inferior third-party sample tubes. Aftermarket tubes are sometimes manufactured to less discriminating standards. Consequently, an analysis performed on a name-brand analytical device 10 might yield unreliable data not because of the analytical device 10, but rather because of the aftermarket tube. To avoid that dilemma, the present invention tubes 12 include an identity tag 14 that is recognizable by the identity tag reader 20.

The identity tag 14 may be any type of tag that can be recognized by an automated reader and which will enable the analysis device 10 (and/or the end-user) to determine the source of the tube as will be described below. A preferred embodiment of the identity tag 14 is a trademark (e.g., see FIG. 4), service mark, or logo (e.g., an indicator of the source of the tube) the use of which can be controlled to avoid counterfeiting of the tube 12. An identity tag 14 that can be controlled to avoid counterfeiting provides the end-user (or analysis device) with a source indicator (i.e., the manufacturing source of the tube 12) that is an indicator of the quality of the tube, and therefore an indicator of the accuracy of the analysis results provided using that tube 12. Another embodiment of the identity tag 14 is one in which features or characters forming the identity tag 14 are encrypted. The identity tag 14 may or may not be visible to the naked human eye, although a visible identity tag 14 can be helpful product discriminator. The present invention is not limited to any particular technique for disposing the identity tag 14 on the tube 12. For example, the identity tag 14 may be attached to the tube 12, or printed on the tube 12, or integrally formed with the tube 12. It should be noted that the present identity tag 14 (e.g., that provides information relating to the manufacturing source of the tube 12) is distinguishable from a label applied to a tube 12 that indicates the origin of the sample disposed within the tube 12; i.e., from patient “X”, or from testing center “Y”. The function of the present identity tag 14 is to provide information relating to the tube 12 itself (e.g., the manufacturing source of the tube, the entity—e.g., a licensor—responsible for having the tube manufactured, an entity responsible for maintaining quality control of the tube, etc.) which information is independent of the sample disposed within the tube 12, where the tube 12 may have been used, the subject or entity associated with the sample disposed in the tube, etc.

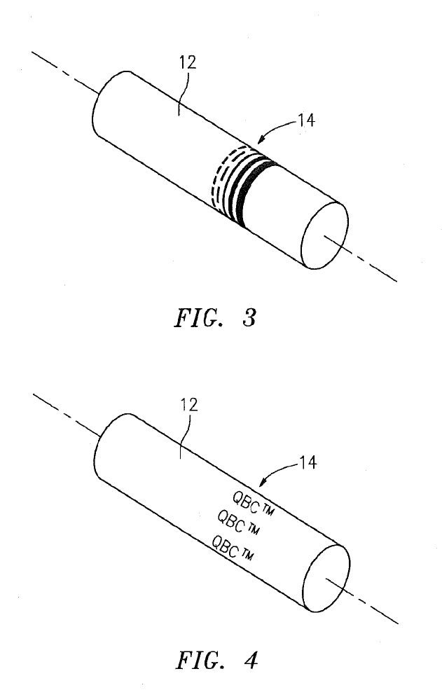

In a further embodiment, the identity tag 14 is configured on each tube 12 so that the identity tag 14 can be recognized by the reader regardless of the circumferential position of the tube 12 relative to the reader. For example, the identity tag 14 may be a design that is continuous and uniform around the circumference of the tube 12; e.g., see FIG. 3. Alternatively, the identity tag 14 may include a particular design (e.g., a logo, or trademark), or a portion of a design, that is disposed at defined positions around the entire circumference of the tube 12; e.g., a logo printed on the tube 12 every forty-five degrees) (45° of the three hundred and sixty degrees) (360° of the tube's circumference (e.g., see FIG. 4). Hence, an imaging unit that is configured to capture one hundred and twenty degrees) (120° of the tube 12 circumference will acquire at least two of the circumferentially spaced designs regardless of the orientation of the tube 12 relative to the reader. Configuring the identity tag 14 in this manner eliminates the possibility that positioning of the tube 12 relative to the reader will be an issue when the present device 10 confirms the source of the tube 12.

In some embodiments, the identity tag may also contain information relating to the manufacturing date of the tube, or an expiration date, or a location where the tube was manufactured. As will be described below, such information can be used to facilitate evaluation of the tube during use. For example, if tubes made before or after a certain date or from a particular manufacturing source or site are deemed to be unacceptable, the identity tag can be used to identify those tubes and distinguish them from tubes produced after or before the critical date, or from tubes produced by other manufacturing sources.

In the operation of the present method and apparatus, a sample of biologic fluid sample is placed within a tube 12 and the tube 12 is inserted into the analysis device 10. At some point during the analysis of the sample, but preferably before the analysis is performed, the reader is operated to inspect the tube 12 for an identity tag 14. If an identity tag 14 is recognized on the tube 12 by the reader, the analysis device 10 may provide an indication to the end-user (or internally within the programming of the analysis device 10) that the sample tube 12 has been authenticated (i.e., the identity tag 14 is read and based on that read and subsequent confirmation or no confirmation, the end-user (or analysis device) has an assurance regarding the manufacturing source of the tube 12). The term “authenticate” is used herein to refer to a process wherein the information available from the identity tag is compared against information programmed into the analysis device to determine the acceptability of the information from the identity tag, and therefore the tube; e.g., an identity tag in the form of a trademark (logo, design, etc.) can be compared against a trademark (logo, design, etc) programmed into the analysis device—if the comparison is favorable, the identity tag, and therefore the tube, is authenticated. If no identity tag 14 is found, or if the identity tag 14 cannot be authenticated by the reader (e.g., the identity tag 14 on the tube 12 is not an appropriate identity tag 14—one that indicates an appropriate source of the tube 12), the end-user is informed prior to the initiation of the analysis that the source of the tube 12 (i.e., the authorized manufacturer, or a licensee thereof) cannot be verified. In some instances, the end-user may also be provided with a warning; e.g., that the analysis results may be compromised because the production source of the tube 12 cannot be verified. In some instances, the analysis device 10 may be programmed to automatically reject a tube 12 lacking the appropriate identity tag 14, or at least temporarily prevent the performance of the analysis; e.g., until some affirmative command is input by the end-user. In some instances, the analysis device 10 can be adapted to recognize and accept more than one identity tag 14.

In those embodiments where the identity tag includes information relating to the manufacturing date of the tube, an expiration date, or the specific location where the tube was manufactured, the analysis device can be programmed to act (e.g., reject the tube, indicate the expiration date has passed, or at least temporarily halt the analysis) based on the manufacturing date, expiration date, or particular location where the tube was manufactured. For example, if tubes manufactured up to a certain date met all quality control criteria, or were properly licensed, and tubes after the date did not meet the criteria or were not properly licensed, the analysis device could be programmed to act based on that information; e.g., reject the tube or halt analysis. As a further example, in instances where tubes are manufactured at multiple locations by a single manufacturing source, and the tubes manufactured at certain of the locations were defective, the information contained within the identity tag could be used to identify those particular tubes for rejection or other corrective action. The criteria necessary to evaluate the information contained within the identity tag could be originally programmed within the analysis device 10, or could be subsequently entered into the analysis device; e.g., by software update electronically transferred by internet, storage medium, etc. The present invention also contemplates combinations of the above described information being included or determinable from the identity tag.

Although this invention has been shown and described with respect to the detailed embodiments thereof, it will be understood by those skilled in the art that various changes in form and detail thereof may be made without departing from the spirit and the scope of the invention.

What is claimed is:

1. An apparatus for analyzing a biologic sample, comprising:
a capillary tube for holding the biologic sample;
a machine readable identity tag disposed on the tube that indicates a production source of the tube; and
an analysis device for analyzing the biologic sample, the device including a reader adapted to read the identity tag, and wherein the analysis device is operable to authenticate the tube based on the identity tag read from the tube.

2. The apparatus of claim 1, wherein the identity tag is one of a trademark, service mark or a logo.

3. The apparatus of claim 1, wherein the identity tag is encrypted.

4. The apparatus of claim 1, wherein the identity tag is invisible to the naked human eye.

5. The apparatus of claim 1, wherein the identity tag is one of attached to the tube, printed on the tube, or integrally formed with the tube.

6. The apparatus of claim 1, wherein the identity tag is configured on the tube such that it can be recognized by the reader regardless of the circumferential position of the tube relative to the reader.

7. The apparatus of claim 6, wherein the identity tag is a design that is continuous and uniform around the circumference of the tube.

8. The apparatus of claim 6, wherein the identity tag includes a design that is disposed at defined positions around the entire circumference of the tube.

9. The apparatus of claim 1, wherein the identity tag includes information relating to one or more of a manufacturing date of the tube, an expiration date of the tube, or a location where the tube was manufactured.

10. A container for holding a biologic fluid sample for analysis for use with an automated analysis device, said container comprising:
a capillary tube for holding the biologic sample; and
a machine readable identity tag disposed on the tube, wherein the identity tag provides information regarding the production source of the tube.

11. The container of claim 10, wherein the identity tag is one of a trademark, service mark or a logo.

12. The container of claim 10, wherein the identity tag is encrypted.

13. The container of claim 10, wherein the identity tag is invisible to the naked human eye.

14. The container of claim 10, wherein the identity tag is one of attached to the tube, printed on the tube, or integrally formed with the tube.

15. The container of claim 10, wherein the identity tag is configured on the tube such that it can be recognized by the analysis device regardless of the circumferential position of the tube relative to the analysis device.

16. The container of claim 15, wherein the identity tag is a design that is continuous and uniform around the circumference of the tube.

17. The container of claim 15, wherein the identity tag includes a design that is disposed at defined positions around the entire circumference of the tube.

18. The container of claim 10, wherein the identity tag includes information relating to one or more of a manufacturing date of the tube, an expiration date of the tube, or a location where the tube was manufactured.

19. A method for analyzing a biologic fluid sample, comprising the steps of:
providing a capillary tube for holding the biologic fluid sample, the tube including a machine readable identity tag disposed on the tube, wherein the identity tag provides information regarding the production source of the tube;
providing an automated analysis device for analyzing the biologic fluid sample, wherein the analysis device includes a reader adapted to read the identity tag and authenticate the tube based on the identity tag;
authenticating the tube using the reader and the identity tag; and
performing an action based on the determined authenticity of the tube.
